(19) United States
(12) Patent Application Publication
(10) Pub. No.: US 2008/0191159 A1
(43) Pub. Date: Aug. 14, 2008

(54) Valve For Controlling an Injection Valve of an Internal Combustion Engine

(76) Inventors: Axel Schnaufer, Calw (DE); Thorsten Schneider, Bisingen (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 11/909,750

(22) PCT Filed: Mar. 8, 2006
(86) PCT No.: PCT/EP2006/060555

§ 371 Date: Sep. 26, 2007

(30) Foreign Application Priority Data
May 2, 2005 (DE) 10 2005 020 360.4

(51) Int. Cl. F16K 1/00

(52) U.S. Cl. 251/318

(57) ABSTRACT

An injection valve of an internal combustion engine comprises a valve portion arranged in a bore of the valve housing, forming a high-pressure side annular chamber sealed in relation to the valve housing by the sealing contact of the valve portion with a shoulder of the bore and at an axial distance therefrom, by a sealing ring. A spacing sleeve is arranged in the annular chamber and keeps the sealing ring at a minimum axial distance from the shoulder of the bore.

### PRIOR ART

The invention relates to a valve for controlling an injection valve of an internal combustion engine as generically defined by the preamble to claim 1.

One such valve has become known for instance from German Patent Disclosure DE 101 46 743 A1.

In known magnet valves of injection systems (common rail injectors), an annular chamber on the high-pressure side is formed between the valve housing (injector body) and a valve portion, and this chamber is sealed off via two axially spaced-apart sealing points, namely via a flat seal and a sealing ring. Because of dynamic processes within the annular chamber on the high-pressure side, however, there is the danger that the sealing ring will lift from its intended sealing seat and close a hydraulic inlet bore in the valve portion of the injector. This can cause constant injection and thus a dangerous loss of function, since the motor then races uncontrollably.

### ADVANTAGES OF THE INVENTION

The valve according to the invention having the characteristics of claim 1 has the advantage over the prior art that “upward creep” of the sealing ring and thus a serious loss of function are reliably prevented. By long-term tests, it has additionally been proven that introducing the additional spacer bush has no influence on the performance graph of the injector, or in other words is neutral in terms of the performance graph.

Further advantages and advantageous features of the subject of the invention will become apparent from the description, drawings, and claims.

### DRAWINGS

One exemplary embodiment of the invention is shown in the drawings and described in further detail in the ensuing description.

FIG. 1 is a longitudinal section through the valve of the invention; and

FIG. 2 shows the spacer bush of FIG. 1 in perspective.

### DESCRIPTION OF THE EXEMPLARY EMBODIMENT

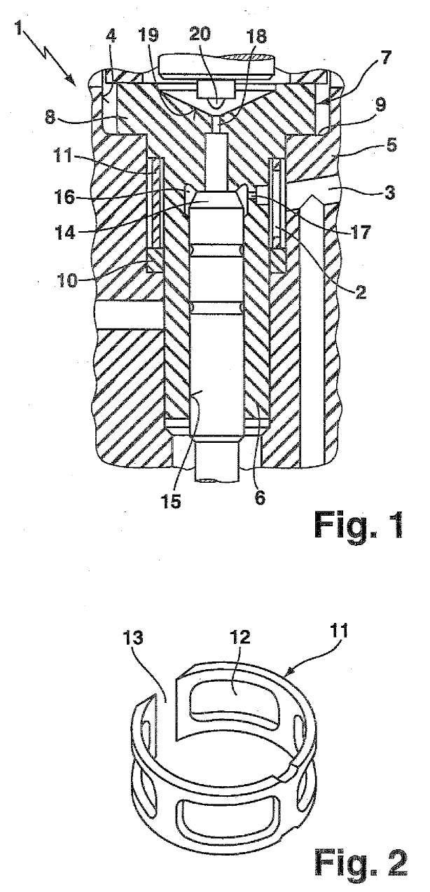

The valve 1 shown in FIG. 1 serves to control an injection valve (injector) of an internal combustion engine and has an annular chamber 2, which is connected via a fuel line 3 to a high-pressure fuel reservoir (common rail), not shown.

The annular chamber 2 on the high-pressure side is formed in a stepped bore 4 of the valve housing 5 by a bushlike guide extension 6 of a valve portion 7, which portion rests with a flange 8 on a shoulder 9 of the bore 4 in a sealing fashion and—spaced apart axially from that—is sealed off on the guide extension 6 from the valve housing 5 by a high-pressure sealing ring (together with a steel support ring beneath it) 10. By means of a valve tightening screw (not shown), the flange 8 is pressed against the shoulder 9.

A spacer bush 11 (valve chamber bush) is disposed in the annular chamber 2 and has a plurality of wall openings 12 (FIG. 2). The spacer bush 11 is slipped onto the guide extension 6 of the valve portion 7 and thus, after installation in the injector, forms a stop for the sealing ring 10 beneath it, which is thus retained at an axial minimum spacing from the shoulder 9 of the bore 4, and thus “upward creep” is prevented. The spacer bush 11 is designed such that twisting on the valve portion 7 cannot have any influence on the function. The ratios of the areas of the sealing ring 10 and the contact with the spacer bush 11 are selected such that the operative forces at high pressure cannot cause “bathing” of the sealing ring 10.

The filigree-like contours and wall openings 12 of the spacer bush 11 are made by laser cutting or punching into a metal sheet (plate), which is then rolled out, forming a slit 13, to make the spacer bush 11. The contours and wall openings 12 are selected such that the function of the valve portion 7 and hence the function of the injection valve are not impaired.

The end of a pistonlike valve member or final control element (valve piston) 14 of the injection valve is guided displaceably in a guide bore 15 of the valve portion 7 and defines a control chamber 16 in the valve portion 7. The control chamber 16 communicates with the annular chamber 2 via an inlet throttle restriction 17 and discharges via an outlet throttle restriction 18 into a valve seat opening of a conical valve seat 19, which is provided on the face end, remote from the guide extension 6, of the valve portion 7 for cooperation with a valve closing member 20.

In the closed valve position, not shown in which the valve closing member rests on the valve seat 19 and thus closes the valve seat opening, the control chamber 16 is subjected to high pressure, and as a result, the valve member or final control element 14 of the injection valve is displaced to its lower position. In the open valve position, shown, the valve dosing member 20 has lifted from the valve seat 19 and uncovered the valve seat opening, as a result of which the control chamber 16 is pressure-relieved, and the valve member or final control element 14 is displaced to its upper position.

1-10. (canceled)

11. A control valve for controlling an injection valve of an internal combustion engine, the control valve comprising a valve housing, a valve portion disposed in a bore of the valve housing and forming an annular chamber on the high-pressure side, which chamber is sealed off from the valve housing by sealing contact of the valve portion with a shoulder of the bore and, spaced apart from that, by a sealing ring, and
a spacer bush disposed in the annular chamber, the spacer bush keeping the sealing ring at an axial minimum spacing from the shoulder of the bore.

12. The valve as defined by claim 11, wherein the spacer bush comprises at least one wall opening.

13. The valve as defined by claim 12, wherein the spacer bush comprises a plurality of wall openings.

14. The valve as defined by claim 13, wherein the plurality of wall openings are distributed uniformly over the circumference of the spacer bush.

15. The valve as defined by claim 1, wherein the axial length of the spacer bush is less than that of the annular chamber.

16. The valve as defined by claim 12, wherein the axial length of the spacer bush is less than that of the annular chamber.

17. The valve as defined by claim 13, wherein the axial length of the spacer bush is less than that of the annular chamber.

18. The valve as defined by claim 14, wherein the axial length of the spacer bush is less than that of the annular chamber.

19. The valve as defined by claim 13, wherein the contours and/or wall openings of the spacer bush are made in the spacer bush by means of laser cutting or punching.

20. The valve as defined by claim 14, wherein the contours and/or wall openings of the spacer bush are made in the spacer bush by means of laser cutting or punching.

21. The valve as defined by claim 15, wherein the contours and/or wall openings of the spacer bush are made in the spacer bush by means of laser cutting or punching.

22. The valve as defined by claim 11, wherein the spacer bush is a longitudinally slit bush.

23. The valve as defined by claim 12, wherein the spacer bush is a longitudinally slit bush.

24. The valve as defined by claim 13, wherein the spacer bush is a longitudinally slit bush.

25. The valve as defined by claim 14, wherein the spacer bush is a longitudinally slit bush.

26. The valve as defined by claim 11, wherein the spacer bush is guided axially displaceably on the valve portion.

27. The valve as defined by claim 22, wherein the spacer bush is guided axially displaceably on the valve portion.

28. The valve as defined by claim 11, wherein the spacer bush is supported rotatably on the valve portion.

29. The valve as defined by claim 26, wherein the spacer bush is supported rotatably on the valve portion.

30. The valve as defined by claim 11, further comprising a control chamber in a guide bore of the valve portion the control chamber being defined by a valve member or final control element guided displaceably in the bore of the injection valve, the control chamber communicating with the annular chamber on the high-pressure side via an inlet throttle restriction and discharging via an outlet throttle restriction into a valve seat opening of a valve seat on the face end of the valve portion facing away from the valve member or final control element for cooperation with a movable valve closing member.
